(19) United States
(12) Patent Application Publication
(10) Pub. No.: US 2019/0047225 A1
(43) Pub. Date: Feb. 14, 2019

(54) ADDITIVE MANUFACTURING APPARATUS AND METHOD FOR DELIVERING MATERIAL TO A DISCHARGE PUMP

(71) Applicant: TYCO CONNECTIVITY CORPORATION, Berwyn, PA (US)

(72) Inventor: Xiaoming LUO, Painted Post, NY (US)

(21) Appl. No.: 15/672,653

(22) Filed: Aug. 9, 2017

(51) Int. Cl. B29C 64/329; B29C 64/227; B29C 64/295; B33Y 30/00

(52) U.S. Cl. CPC B29C 64/329; B33Y 30/00; B29C 64/295; B29C 64/227

(57) ABSTRACT

An additive manufacturing apparatus and method having a flexible delivery system for delivering pellets from a stationary material receiving area to a movable discharge pump. The flexible delivery system includes a flexible tube, an air compressor and an air-material separator. The air compressor is connected to an end of the flexible tube to direct controlled compressed air through the flexible tube. The air-material separator has a material receiving chamber which receives the pellets from the flexible tube through a material receiving opening. The material receiving chamber extends to a nozzle feeding opening and a nozzle feeding tube. The material receiving chamber has an exhaust opening through which the compressed air is vented out of the air-material separator.

### FIELD OF THE INVENTION

The present invention is directed to an apparatus and method for delivering material to a discharge pump for the production of a three-dimensional object from polymer material. In particular, the invention is directed to an apparatus having a material conveying system.

### BACKGROUND OF THE INVENTION

Various three-dimensional printing devices are currently available to produce parts from 3D data. Additive manufacturing, such as three-dimensional (3D) printing refers to processes that create 3D objects based on digital 3D object models and a materials dispenser. In 3D printing, a dispenser moves in at least 2-dimensions and dispenses material according to a determined print pattern. To build a 3D object, a platform that holds the object being printed is adjusted such that the dispenser is able to apply many layers of material. In other words, a 3D object may be printed by printing many layers of material, one layer at a time. If the dispenser moves in 3-dimensions, movement of the platform is not needed. 3D printing features such as speed, accuracy, color options and cost vary for different dispensing mechanisms and materials.

Many additive processes and machines feed continuous polymer filaments driven by electrical motors into heated extruders. However, it is often desirable to use polymer material in pellet or granule form. Therefore, a procedure of transferring pellets into filament is needed in order to use filament feeding 3D printing extruders. However, with many pellet feed extruders, the maximum extrusion pressure is restricted by polymer material compressive strength and filament delivery system capability. For some materials, this compressive strength is relatively small.

In order to accommodate the use of various materials, 3D printer extruders which drive polymer melt out of a nozzle with a screw pump are being adopted. These extruders often use polymer pellets or granules as the input material. One benefit of this extruder design is that it can push the polymer melt out of the nozzle with high pressure. In order to feed pellets into the screw pump, a pellet hopper is usually attached to the extruder. The heavy pellet hopper reduces mobility of the extruder. In some instances, the weight of the hopper/extruder assembly requires that the extruder assembly be stationary during printing, necessitating that the build platform underneath of the extruder system conduct the 3D printing motions.

It would, therefore, be beneficial to provide a system, apparatus and method in which the stationary material hoppers are separated from the polymer extruder. In addition, it would be beneficial to provide a system, apparatus and method in which pellets are delivered into extruder screw pump with a pneumatic conveying mechanism, so that the mobility of the extruder head can be improved by reducing mass and size. It would also be beneficial to provide a system, apparatus and method which includes multiple pellet hoppers so that printing material switching or mixing will be easily realized.

### SUMMARY OF THE INVENTION

An object is to provide a system, apparatus and/or method in which the stationary material hoppers are separated from the polymer extruder.

An object is to provide a system, apparatus and/or method in which material, for example in the form of pellets, is delivered into an extruder screw pump with a pneumatic conveying mechanism, so that the mobility of the extruder head can be improved by reducing mass and size.

An object is to provide a system, apparatus and/or method which includes multiple material receiving hoppers so that printing material switching or mixing will be easily realized.

An embodiment is directed to an additive manufacturing apparatus which includes a stationary material receiving area, a movable discharge pump and a flexible delivery system. The stationary material receiving area receives material to be used in the additive manufacturing process. The movable discharge pump controls the flow of the material to a build platform. The flexible delivery system delivers the material from the stationary material receiving area to the movable discharge pump. The flexible delivery includes a flexible tube and an air-material separator. The air-material separator has a material receiving chamber which receives the material from the flexible tube through a material receiving opening. The material receiving chamber extends to a nozzle feeding opening and a nozzle feeding tube.

An embodiment is directed to an additive manufacturing apparatus having a flexible delivery system for delivering pellets from a stationary material receiving area to a movable discharge pump. The flexible delivery system includes a flexible tube, an air compressor and an air-material separator. The air compressor is connected to an end of the flexible tube to direct controlled compressed air through the flexible tube. The air-material separator has a material receiving chamber which receives the pellets from the flexible tube through a material receiving opening. The material receiving chamber extends to a nozzle feeding opening and a nozzle feeding tube. The material receiving chamber has an exhaust opening through which the compressed air is vented out of the air-material separator.

An embodiment is directed to a method of delivering pellets to a discharge pump in an additive manufacturing process. The method includes: generating an air flow in a tube or channel which receives the pellets; feeding the pellets into the tube or channel at a first location; extracting with an air-pellet separator the pellets from the tube or channel at a second location which is remote from the first location; exhausting the air flow from the air-pellet separator; and advancing the pellets to the discharge pump.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an illustrative embodiment of a three-dimensional printing apparatus according to the present invention, including a discharge pump which is movably attached to a hopper.

FIG. 2 is an enlarged perspective view of the hopper attached to a flexible tube which transports material exiting the hopper to the discharge pump.

FIG. 3 is an enlarged cross-sectional view of an air-material separator of the flexible tube and the discharge pump.

FIG. 4 is a flow chart of an illustrative method of delivering material to the discharge pump.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

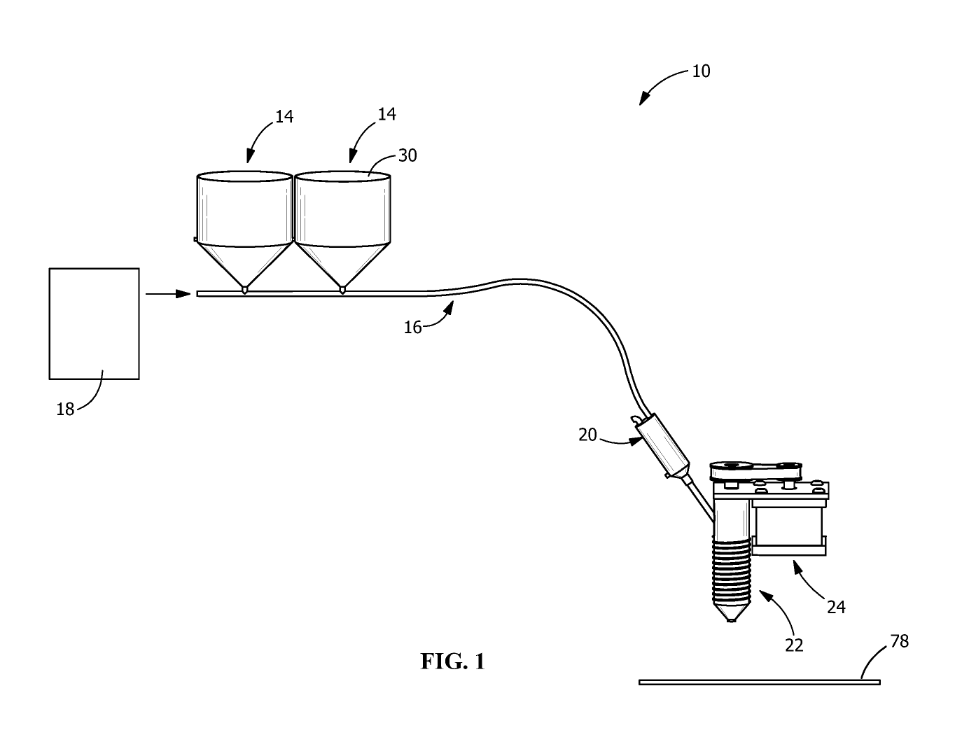

Referring to FIG. 1, the three-dimensional printing apparatus 10 includes one or more material receiving areas or hoppers 14, a flexible tube or channel 16, an air compressor 18, an air-material separator 20, a screw pump or extruding head 22 and a motor 24. The material receiving area or hopper 14, the flexible tube 16, the air compressor 18, and the air-material separator 20 are all part of a flexible pneumatic material conveying or delivery system.

Other components may be included with the three-dimensional printing apparatus 10 without departing from the scope of the invention. In general, the three-dimensional printing apparatus 10 is configured to allow a wide range of materials to be used to produce a three-dimensional object, such as, but not limited to, polymers, which may include, but are not limited to, filled polymers in the form of pellets or other ground forms. The materials can also include regrind. Any number of other materials can be used provided they are plasticizable by the device and are dischargeable by the discharge pump 22.

While only one three-dimensional printing apparatus 10 is shown, other similar three-dimensional printing apparatus 10 may be added and used in parallel to either increase production rates or provide additional material types such as support materials or other colors. Additionally, multiple material hoppers 14 may be incorporated into the three-dimensional printing apparatus 10, allowing additional material types such as support materials or other colors to be feed to the extruding head 22. If multiple material hoppers 14 are used, the material switching and mixing can be easily realized by switching on and off the respective hoppers.

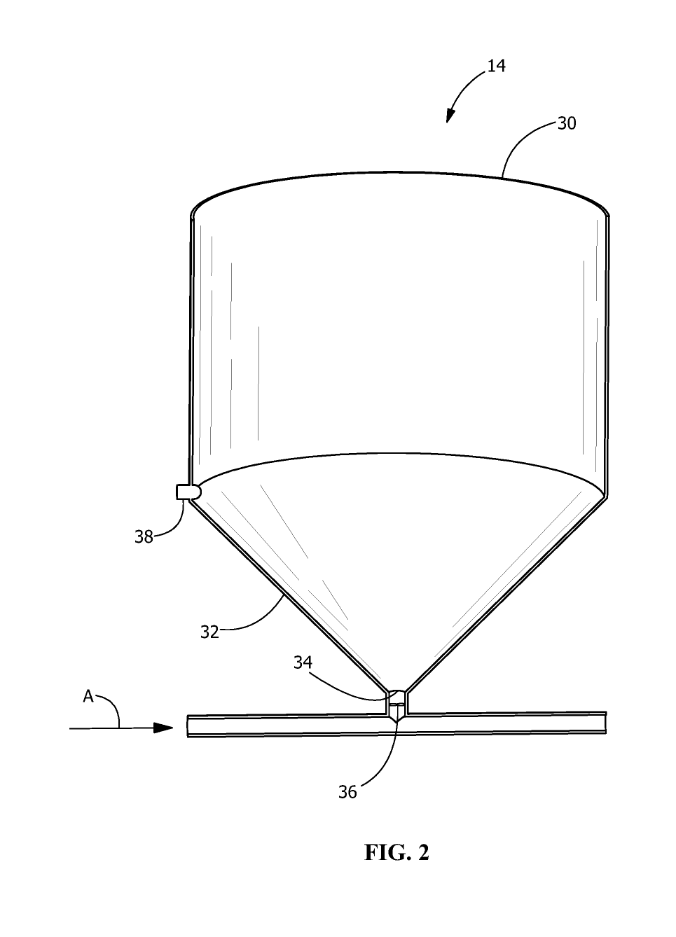

As best shown in FIG. 2, each hopper 14, positioned at a first location, has a material receiving opening 30 which receives and holds the pellets or material therein. Sloped surfaces 32 are provided at the bottom of the opening 30 to feed the material into the tube receiving opening 34. In the embodiment shown, the material is fed into the tube receiving opening 34 and the flexible tube 16 by gravity. However, other methods can be used to feed the material to the flexible tube 16.

A material or pellet separator 36 may be provided in the opening 34 to control the flow of material from the hopper 14 to the flexible tube 16. In the illustrative embodiment shown, the material separator 36 is in the shape of fan blades. A handle or actuator (not shown) may be connected to the material separator center axis for controlling material flow speed manually or automatically. Other devices may be used as the material separator without departing from the scope of the invention.

A proximity sensor 38 may be provided on the hopper to monitor the level or amount of material or pellets inside the hopper 14. Any known proximity sensor which is capable of sending the material may be used. Such proximity sensors include, but are not limited to, capacitive or photoelectric sensors.

Air compressor 18 (FIG. 1) is connected to an end of the flexible tube 16. The air compressor 18 directs a controlled compressed air flow through the flexible tube 16, as indicated by arrow A in FIG. 2. As material or pellets enter the flexible tube 16 from the material or pellet separator 36 of the hopper 14, the compressed air forces the materials from the material separator 36 to the air-material separator 20.

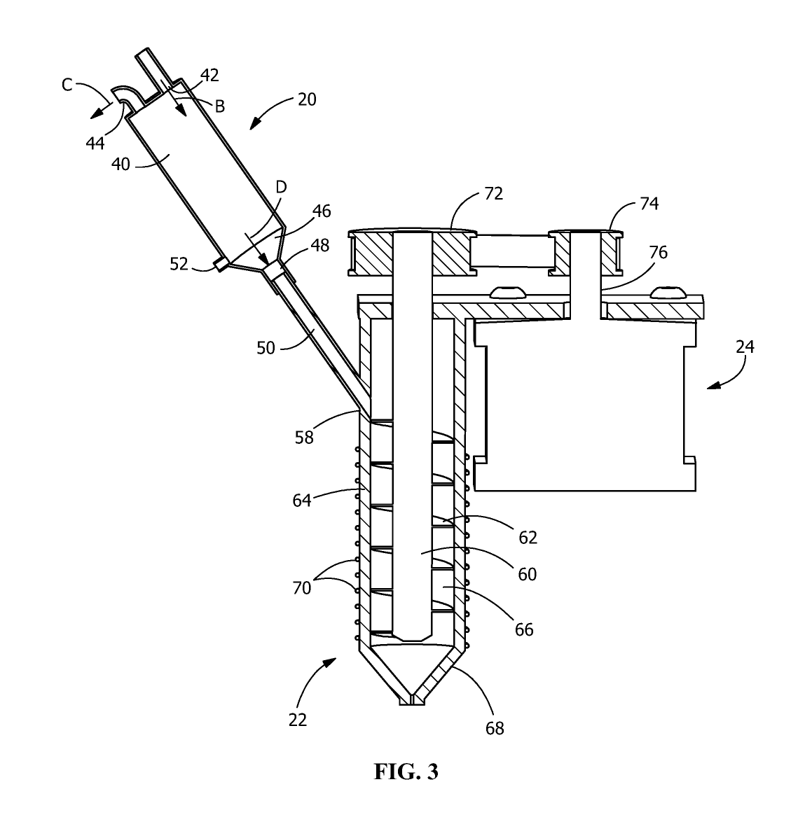

As best shown in FIG. 3, the air-material separator 20, which is at a second location spaced from or remote from the hoppers 14, has a material receiving chamber 40 which receives the material and compressed air from the flexible tube 16 through a material receiving opening 42, as indicated by arrow B. The compressed air received in the material receiving chamber 40 is exhausted or vented out of the air-material separator 20 and the pneumatic material conveying system through an exhaust opening 44 positioned at the top of air-material separator 20 proximate the material receiving opening 42, as indicated by arrow C. Tapered surfaces 46 are provided at the bottom of the chamber 40 and extend to a nozzle feeding opening 48 and a nozzle feeding tube 50. In the embodiment shown, the material is advanced or fed into the nozzle feeding opening 48 and a nozzle feeding tube 50 through the tapered surfaces 46 by gravity and residual force applied to the material by the compressed air, as indicated by arrow D.

A proximity sensor 52 may be provided on the air-pellet separator 20 to monitor the level or amount of material or pellets inside the chamber 40 of the air-material separator 20. Any known proximity sensor which is capable of sending the material may be used. Such proximity sensors include, but are not limited to, capacitive or photoelectric sensors.

The material enters the discharge pump or extruding head 22 through material receiving opening 58. In the illustrative embodiment shown, the discharge pump 22 includes a screw or auger 60 with threads 62 extending about the periphery of the auger 60. The auger 60 and threads 62 are position in a cavity 66. In the embodiment shown, the threads 62 are spaced apart by approximately 0.05 inches (1.3 mm). However, other spacing may be used without departing from the scope of the invention.

The screw design shown in FIG. 3 is one illustrative embodiment of the screw design. Various other screw designs can be used. For example, in order to better control the pressure, volume and flow rate of various material, the diameter of the core shaft of the auger 60 may be varied and/or the spacing or pitch of the threads 62 may be varied.

A peripheral wall 64 of the cavity 66 is positioned proximate to the outside edges of the threads 62. In order to provide the pressure, volume and flow rates required, the tolerances between the threads 62 and the wall 64 of the cavity 66 must be tightly controlled. For example, tolerances may be controlled to within 0.0002 of an inch (0.005 mm).

The auger 60 and threads 62 are rotatably driven at a desired speed by an appropriate sized motor 24 or the like through couplings 72, 74 which are connected to a drive shaft 76 of the motor 24. This allows the auger 60 and threads 62 to control the flow of the material. In the embodiment shown, the motor 24 is positioned next to the discharge pump 22. However, the motor 24 may be placed in other locations, including, but not limited to, above the discharge pump 22. In such locations, the couplings 72, 74 may have a different configuration or may be eliminated.

Heating coils 70 are provided around the outside periphery of the wall 64. The heating coils 70 may be configured to provide one heating zone or may be configured to provide multiple heating zones. If multiple heating zones are provided, the heating zones are positioned to progressively heat the material as it moves along the length of the discharge pump 22 in the area where the threads 62 are provided. The heating zones may have temperature sensors which allow the heating zones to be properly monitored and controlled.

As the material is moved through the auger 60 and threads 62, shear forces are applied to the material. This allows the material to be melted at lower temperatures, thereby conserving energy and preventing the degradation of the material due to excessive heating.

In use, material is fed into the discharge pump 22 through material receiving opening 58. In the embodiment shown, the material receiving opening 58 is positioned above the threads 62 of the auger 60. As the auger 60 and threads 62 are rotated, the material is forced downward toward the nozzle 68. As this occurs, the material is heated and melted to create a polymer melt. The polymer melt is moved toward and extruded out of the nozzle 68 as needed, which in turn deposits the material onto a build platform 78 (FIG. 2) or other similar surface.

In alternate embodiments, the discharge pump 22 may be in the form of a controlled flow rate pump or a constant flow rate pump depending upon the application. Additionally, if increased pressure is needed, a discharge pump 22 with multiple augers 60 may be used.

The discharge pump 22 may be modular, allowing the discharge pump 22 to be removed and replaced with an alternate discharge pump depending upon the application and the object to be created, thereby allowing the volume of the material, etc. to be varied.

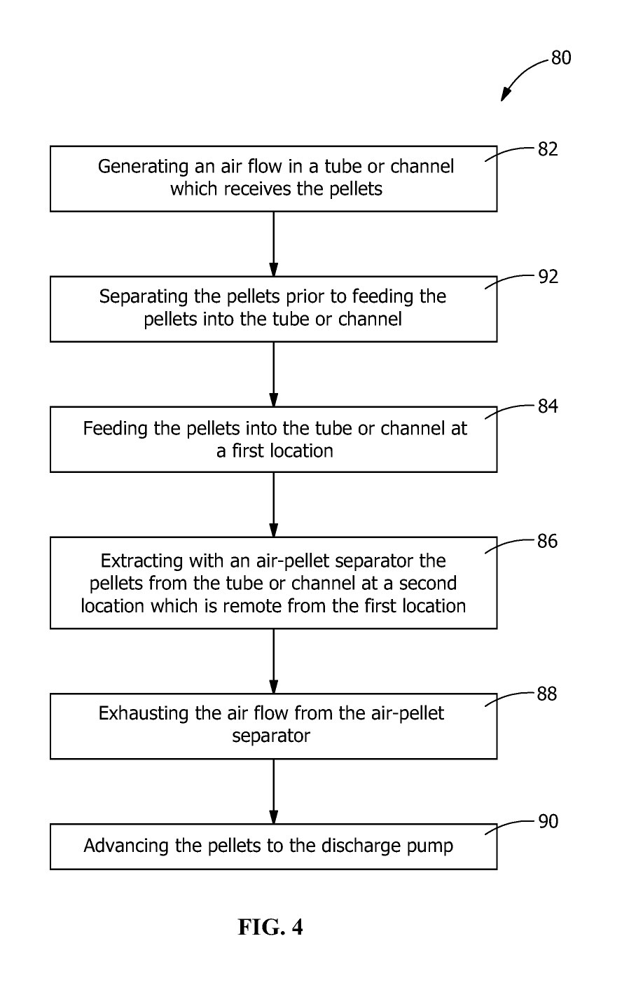

As shown in FIG. 4, the method 80 of delivering pellets to a discharge pump in an additive manufacturing process includes the steps of: generating an air flow in a tube or channel which receives the pellets 82; feeding the pellets into the tube or channel at a first location 84; extracting with an air-pellet separator the pellets from the tube or channel at a second location which is remote from the first location 86; exhausting the air flow from the air-pellet separator 88; advancing the pellets to the discharge pump 90. Other steps such as, but not limited to, separating the pellets prior to feeding the pellets into the tube or channel 92, may also be included.

The apparatus and method described herein allows most of the material to be maintained out of the printer motion zone, delivering a controlled amount of material to the extrusion head as needed. This allows many of the components of the apparatus, including the hopper and air compressor, to remain stationary while allowing the extrusion head to remain mobile relative to the build plate

In general, an apparatus has a movable extruder head connected to one or multiple stationary material hoppers through flexible tubes. Polymer material or pellets are delivered into extruder screw pump by air flow. Inside the extruder screw pump, the polymer material is changed into polymer melt and extruded out of nozzle as needed for building 3D objects. The presently disclosed embodiments are therefore to be considered in all respects as illustrative and not restrictive.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention.

1. An additive manufacturing apparatus comprising:
a stationary material receiving area for receiving material to be used in an additive manufacturing process;
a movable discharge pump which controls the flow of the material to a build platform;
a flexible delivery system which delivers the material from the stationary material receiving area to the movable discharge pump, the flexible delivery system comprising:
a flexible tube; and
an air-material separator having a material receiving chamber which receives the material from the flexible tube through a material receiving opening, the material receiving chamber extending to a nozzle feeding opening and a nozzle feeding tube.

2. The additive manufacturing apparatus as recited in claim 1, wherein an air compressor is connected to an end of the flexible tube to direct controlled compressed air through the flexible tube.

3. The additive manufacturing apparatus as recited in claim 2, wherein the air-material separator has a material receiving chamber which receives the material and compressed air from the flexible tube through a material receiving opening.

4. The additive manufacturing apparatus as recited in claim 3, wherein the material receiving chamber has an exhaust opening through which the compressed air is vented out of the air-material separator.

5. The additive manufacturing apparatus as recited in claim 1, wherein tapered surfaces of the material receiving chamber extend to the nozzle feeding opening and a nozzle feeding tube.

6. The additive manufacturing apparatus as recited in claim 1, wherein a proximity sensor is provided on the air-material separator to monitor the level or amount of material inside the material receiving chamber

7. The additive manufacturing apparatus as recited in claim 1, wherein the stationary material receiving area has one or more hoppers for receiving the material therein.

8. The additive manufacturing apparatus as recited in claim 7, wherein a material separator is provided in an opening of each respective hopper to control the flow of the material from the respective hopper to the flexible tube.

9. The additive manufacturing apparatus as recited in claim 1, wherein the discharge pump has an auger with threads extending about the periphery of the auger, the auger and threads positioned in a cavity of the discharge pump.

10. The additive manufacturing apparatus as recited in claim 9, wherein a movable motor drives the auger and threads at a desired speed to control the flow of the material.

11. The additive manufacturing apparatus as recited in claim 1, wherein heating coils are positioned on the discharge pump.

12. The additive manufacturing apparatus as recited in claim 11, wherein the heating coils are arranged in multiple heating zones to progressively heat the material as it moves through the discharge pump.

13. The additive manufacturing apparatus as recited in claim 1, wherein the discharge pump is a controlled flow pump.

14. The additive manufacturing apparatus as recited in claim 1, wherein the discharge pump is a constant flow pump.

15. An additive manufacturing apparatus having a flexible delivery system for delivering pellets from a stationary material receiving area to a movable discharge pump, the flexible delivery system comprising:
a flexible tube;
an air compressor connected to an end of the flexible tube to direct controlled compressed air through the flexible tube;
an air-material separator having a material receiving chamber which receives the pellets from the flexible tube through a material receiving opening;
the material receiving chamber extending to a nozzle feeding opening and a nozzle feeding tube; and
the material receiving chamber having an exhaust opening through which the compressed air is vented out of the air-material separator.

16. The additive manufacturing apparatus as recited in claim 15, wherein a stationary material receiving area for receiving the pellets is connected to and feeds the pellets into the flexible tube.

17. The additive manufacturing apparatus as recited in claim 16, wherein the stationary material receiving area has one or more hoppers for receiving the pellets therein.

18. The additive manufacturing apparatus as recited in claim 17, wherein a material separator is provided in an opening of each respective hopper to control the flow of the pellets from the respective hopper to the flexible tube.

19. A method of delivering pellets to a discharge pump in an additive manufacturing process, the method comprising:
generating an air flow in a tube or channel which receives the pellets;
feeding the pellets into the tube or channel at a first location;
extracting with an air-pellet separator the pellets from the tube or channel at a second location which is remote from the first location;
exhausting the air flow from the air-pellet separator; and
advancing the pellets to the discharge pump.

20. The method of claim 19, comprising separating the pellets prior to feeding the pellets into the tube or channel.
